(19) United States
(12) Patent Application Publication
(10) Pub. No.: US 2017/0090640 A1
(43) Pub. Date: Mar. 30, 2017

(54) THEREMIN-BASED POSITIONING

(71) Applicant: Intel Corporation, Santa Clara, CA (US)

(72) Inventors: RICHARD D. ROBERTS, Hillsboro, OR (US); JAROSLAW J. SYDIR, San Jose, CA (US); JEFFREY R. FOERSTER, Portland, OR (US); VALLABHAJOSYULA S. SOMAYAZULU, Portland, OR (US); YITING LIAO, Hillsboro, OR (US)

(73) Assignee: Intel Corporation, Santa Clara, CA (US)

(21) Appl. No.: 14/863,963

(22) Filed: Sep. 24, 2015

(51) Int. Cl. G06F 3/041; G06F 3/044; G06F 3/01

(52) U.S. Cl. CPC G06F 3/0416; G06F 3/017; G06F 3/044; G06F 3/0412; G06F 2203/04108

(57) ABSTRACT

This disclosure pertains to Theremin-based positioning. In general, Theremin technology may operate based on changes in frequency that may be induced in a signal when a certain object (e.g., a user's hand) is proximate to a capacitive electrode. An example system may comprise at least four capacitive electrodes in an arrangement that reacts to proximate objects. A change in frequency sensed for any of the at least four capacitive electrodes may trigger a determination of distance from each of the capacitive electrodes to the object based on the frequency change, and a determination of object positioning data based on the distances. Embodiments may include, for example, the ability to verify the arrangement of the at least four capacitive electrodes, determine object position and/or orientation in a coordinate system referenced to the at least four capacitive electrodes, determine object motion, provide the positioning data to a requesting application, etc.

### TECHNICAL FIELD

The present disclosure relates to positioning, and more particularly, to a system that may determine position for proximate objects utilizing frequency changes in Theremin-based sensors.

### BACKGROUND

As interaction more frequently takes place utilizing electronic communication, the overall reliance of modern society on electronic devices continues to grow. Various applications may be loaded and launched on electronic devices to, for example, facilitate personal and/or professional communication, personal and/or professional financial transactions, navigation, the presentation of multimedia information (e.g., entertainment programming, games, etc.). Moreover, electronic communication circuitry is beginning to be integrated into various applications that traditionally did not include the ability to communicate electronically, resulting in an ever expanding category of “smart” devices. Users may interact with electronic devices at home, at work, when operating a motor vehicle, when riding on public transportation, when attending public events (e.g., sports, entertainment, educational forums, etc.) As a result, the usage of electronic devices has grown to be nearly ubiquitous.

While the benefits of the above expansion in electronic technology are readily apparent, there are also potential drawbacks. The use of electronic devices in some situations may present a distraction that may prove to be dangerous to the users or others. For example, a user may not be able to interact directly with a device when operating an automobile. Vehicle manufacturers have tried to alleviate this situation with various integrated car systems. However, actuating the controls for these integrated systems may also prove to be a distraction. Other usage situations may place an actual device to be controlled at some distance from a user. Extending the reach of traditional user interface equipment coupled to the device to be controlled may be impossible, or at least cumbersome. Some operational environments (e.g., extremely caustic and/or explosive manufacturing environments) do not allow a user to interact directly with a device, and/or may require the user to interact with the device at some distance and/or possibly behind a protective barrier. Traditional peripherals and/or or remote control scheme based on, for example, vision-based motion or position sensing may not be capable of accommodating all of these situations.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example system for Theremin-based positioning in accordance with at least one embodiment of the present disclosure;

FIG. 2 illustrates an example configuration for a device usable in accordance with at least one embodiment of the present disclosure;

FIG. 3 illustrates example Theremin circuitry in accordance with at least one embodiment of the present disclosure;

FIG. 4 illustrates an example graph of a frequency to location relationship in accordance with at least one embodiment of the present disclosure; and

FIG. 5 illustrates example operations for Theremin-based positioning in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

This disclosure pertains to Theremin-based positioning. In general, Theremin technology may operate based on changes in frequency that may be induced in a signal when a certain object (e.g., a user's hand) is proximate to a capacitive electrode. An example system may comprise at least four capacitive electrodes in an arrangement that reacts to proximate objects. A change in frequency sensed for any of the at least four capacitive electrodes may trigger a determination of distance from each of the capacitive electrodes to the object based on the frequency change, and a determination of object positioning data based on the distances. Embodiments may include, for example, the ability to verify the arrangement of the at least four capacitive electrodes, determine object position and/or orientation in a coordinate system referenced to the at least four capacitive electrodes, determine object motion, provide the positioning data to a requesting application, etc.

In at least one embodiment, a system to determine positioning data related to proximate objects may comprise, for example, Theremin circuitry and processing circuitry. The Theremin circuitry may be to generate a variable frequency signals and sense variations in the frequencies of the signals induced by an object proximate to the Theremin circuitry. The processing circuitry may be to at least determine distances to the object based on the induced frequency changes and determine positioning data for the object based on the distances.

In at least one embodiment, the Theremin circuitry may comprise, for example, at least four capacitive electrodes to induce variation in the signals when the object is proximate to the capacitive electrodes. The at least four capacitive electrodes may be arranged on a device to be controlled by movement proximate to the device. In at least one example implementation, at least one of the at least four capacitive electrodes may be arranged so as not to be in the same plane as the remaining capacitive electrodes. The arrangement of the at least four capacitive electrodes may be tested to determine if a condition number relationship for the arrangement approaches unity. The Theremin circuitry may further comprise variable frequency oscillator circuitry, frequency change detector circuitry and filtering circuitry coupled to the at least four capacitive electrodes. Moreover, the Theremin circuitry may further comprise a multiplexer to couple the at least four capacitive sensors to the variable frequency oscillator circuitry.

In at least one embodiment, the processing circuitry may comprise position determination circuitry to at least determine the distances based on the induced frequency changes and a constant characterized for each of the at least four capacitive electrodes and the variable frequency oscillator circuitry. The position determination circuitry may be to at least determine coordinates corresponding to a location of the object in a coordinate system defined based on an arrangement of the at least four capacitive electrodes by inputting the distances into a set of closed form simultaneous equations. In another example implementation, the system may further comprise memory circuitry and the position determination circuitry is to at least determine coordinates corresponding to a location of the object in a coordinate system defined based on an arrangement of the at least four capacitive electrodes by inputting the distances into a lookup table in the memory circuitry. The positioning data may comprise, for example, at least one of an object position, object orientation, object motion, object acceleration or object speed. Consistent with the present disclosure, a method for Theremin-based positioning may comprise, for example, initializing a Theremin-based positioning system, sensing frequencies in variable frequency signals generated by Theremin circuitry, determining if at least one frequency in the sensed frequencies has changed based on an object in proximity to the Theremin circuitry, determining at least one distance to the object from the Theremin circuitry based at least on any determined frequency changes and determining positioning data for the object based at least on the at least one distance.

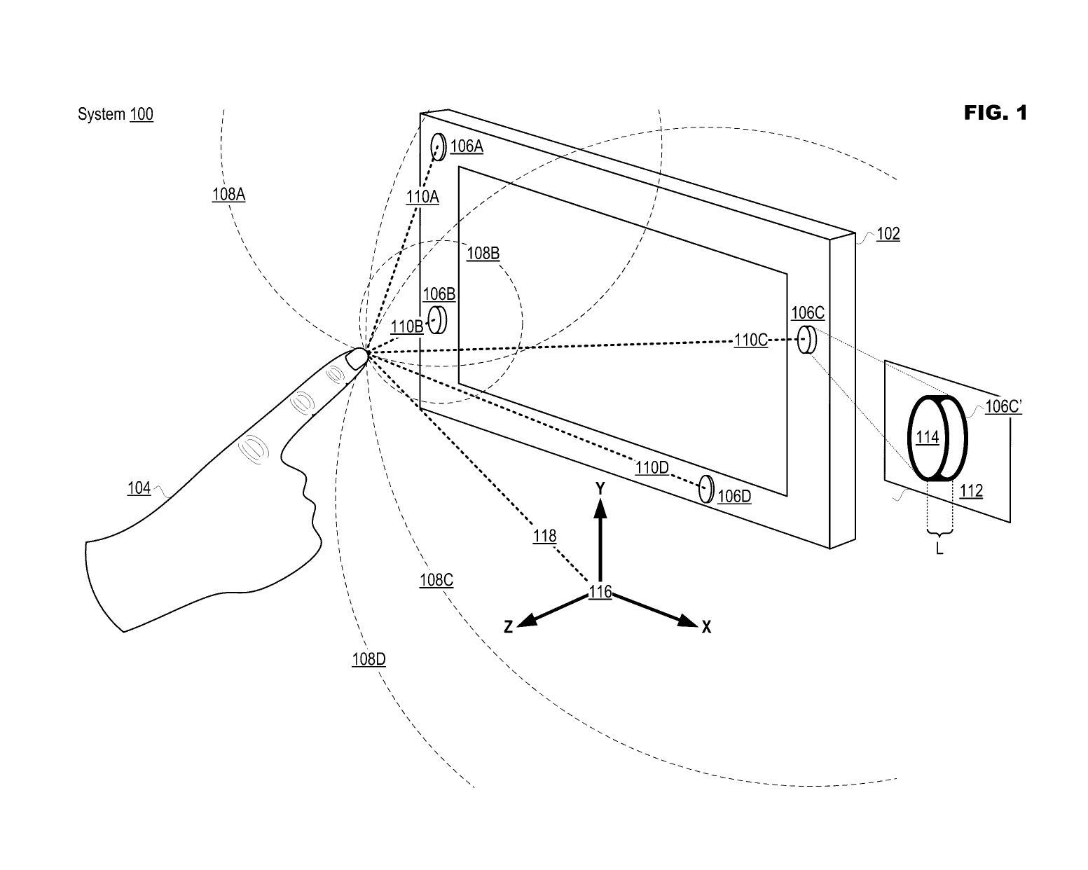

FIG. 1 illustrates an example system for Theremin-based positioning in accordance with at least one embodiment of the present disclosure. Various implementations are discussed herein employing technologies such as Theremin oscillators and/or applications such as gesture-based control systems. These particular technologies and/or applications are offered merely as readily comprehensible examples from which the various teachings discussed herein may be understood. Other technologies, applications, etc. may be implemented consistent with the present disclosure. In addition, the inclusion of an apostrophe after an item number in a drawing figure (e.g., 100′) may indicate that an example embodiment of the particular item is being shown. These example embodiments are not intended to limit the present disclosure to only what is illustrated, and have been presented herein merely for the sake of explanation. As referenced herein, Theremin-based technology may include devices, circuitry, software, etc. designed to operate utilizing the general principles associated with the Theremin musical instrument developed by Leon Theremin in the early 20^{th} century. General principles and operation for the Theremin will be discussed below.

System 100 may comprise, for example, at least device 102 controllable by user who is illustrated in FIG. 1 by hand 104. Device 102 may be an electronic apparatus capable of at least receiving data, processing data and outputting data. Examples of device 102 may include, but are not limited to, a mobile communication device such as a cellular handset or a smartphone based on the Android® OS from the Google Corporation, iOS® or Mac OS® from the Apple Corporation, Windows® OS from the Microsoft Corporation, Linux® OS, Tizen® OS and/or other similar operating systems that may be deemed derivatives of Linux® OS from the Linux Foundation, Firefox® OS from the Mozilla Project, Blackberry® OS from the Blackberry Corporation, Palm® OS from the Hewlett-Packard Corporation, Symbian® OS from the Symbian Foundation, etc., a mobile computing device such as a tablet computer like an iPad® from the Apple Corporation, Surface® from the Microsoft Corporation, Galaxy Tab® from the Samsung Corporation, Kindle® from the Amazon Corporation, etc., an Ultrabook® including a low-power chipset from the Intel Corporation, a netbook, a notebook, a laptop, a palmtop, etc., a wearable device such as a wristwatch form factor computing device like the Galaxy Gear® from Samsung, Apple Watch® from the Apple Corporation, etc., an eyewear form factor computing device/user interface like Google Glass® from the Google Corporation, a virtual reality (VR) headset device like the Gear VR® from the Samsung Corporation, the Oculus Rift® from the Oculus VR Corporation, etc., a typically stationary computing device such as a desktop computer, a server, a group of computing devices organized in a high performance computing (HPC) architecture, a smart television or other type of “smart” device, small form factor computing solutions (e.g., for space-limited applications, TV set-top boxes, etc.) like the Next Unit of Computing (NUC) platform from the Intel Corporation, etc. While device 102 is pictured as a single apparatus, device 102 may actually be constructed from a combination of similarly-configured devices (e.g., a group of rack or edge servers) or differently-configured devices (e.g., a device including at least sensor circuitry and a separate data processing device).

In the example illustrated in FIG. 1, device 102 may be a computer monitor, television, tablet computer, smart phone, etc. equipped with Theremin-based positioning circuitry including at least capacitive electrodes 106A, 106B, 106C and 106D (collectively, electrodes 106A . . . D). While at least four electrodes 106A . . . D are shown as a basic requirement of three-dimensional (3-D) positioning, additional capacitive electrodes may be employed based on, for example, the amount of precision, speed, etc. required when determining the position of hand 104. Moreover, electrode 106C is shown in FIG. 1 in more detail at 106C′. Electrode 106C′ demonstrates that, consistent with the present disclosure, the configuration of each electrode 106A . . . D may vary. For example, a length “L” between surface 112 of device 102′ to proximity sensing surface 114 of each electrode 106A . . . D may be different. Varying L for at least one of electrodes 106A . . . D may be important to ensure that proximity sensing surfaces 114 do not all fall in the same plane, which may increase positioning accuracy. Testing that may help determine a condition number indicative of expected positioning accuracy is discussed below in more detail.

In general, Theremin-based positioning circuitry may generate signals having a frequency varying based on the position of objects proximate to electrodes 106A . . . D. For example, signal 108A is shown as an arc centered on electrode 106A, signal 108B as an arc centered on electrode 106B, signal 108C as an arc centered on electrode 106C and signal 108D as an arc centered on electrode 106D (collectively, signals 108A . . . D). A relationship between distance and frequency may be used to determine a distance between hand 104 and each of electrodes 106A . . . D. The distance from each electrode 106A . . . D to hand 104 may be determined based on the radius of the arc of each signal 108A . . . D, which is determined based on the resulting frequency change when hand 104 is near electrodes 106 A . . . D. For example, the distance (e.g. radius) from hand 104 to electrode 106A may be distance 110A, from hand 104 to electrode 106B may be distance 110B, from hand 104 to electrode 106C may be distance 110C and from hand 104 to electrode 106D may be distance 110D (collectively, distances 110A . . . D). Distances 110A . . . D may be used to determine positioning data related to hand 104. Positioning related data may comprise various types of data related to the disposition of hand 104. For example, position 118 (e.g., a set of coordinates) may be determined in coordinate system 116 for hand 104. Consistent with the present disclosure, coordinate system 116 may be relative to electrodes 106A . . . D, relative to device 102 (e.g., to a display surface), may be translated into an absolute coordinate system such as Global Positioning System (GPS) coordinates, etc. Coordinate system 116 may be important at least from the standpoint that a requestor of the positioning data (e.g., an application running on device 102, a data processing device coupled to device 102, etc.) must know the reference to which position 118 corresponds to react appropriately to the positioning data. The position of hand 104 may be used to control the operation of device 102. For example, a cursor displayed on device 102 may correspond to the position of hand 104. Other examples of positioning data may include, but are not limited to, orientation data for hand 104, motion data for hand 104 that may include, for example, vector data (speed and direction data), acceleration data, speed data, etc. This type of positioning information may be used to, for example, identify gestures that are made by a user with hand 104 to initiate various activities in device 102 such as turning on/off device 102, manipulating a cursor in device 102, changing settings in device 102, activating or terminating applications in device 102, interacting with applications shown on device 102, etc.

While device 102 is shown as a monitor in FIG. 1, other types of devices 102 may sense position 118 corresponding to hand 104, or another object capable of altering the frequency of signals 108A . . . D based on proximity to electrodes 106A . . . D, and may execute operations based on the positioning data. For example, a simple light switch may be turned on and off based on the positioning data (e.g., based on motion, orientation change, etc.). The rate at which position 118 changes may also be used to control different operations in device 102. For example, a slow gesture may cause a first operation to occur while the same motion performed more quickly may cause a totally different operation to occur. Consistent with the present disclosure, at least one benefit that may be realized in Theremin-based positioning is that position, orientation, motion, etc. for hand 104 may be determined without the sensitivity of other solutions. For example, vision based solutions may present privacy concerns and be sensitive to light, background, etc. Other positioning solutions using technologies such as ultrasound, radar, Light radar (LIDAR), etc. may provide comparable results, but implementation may be more complicated, costly, etc.

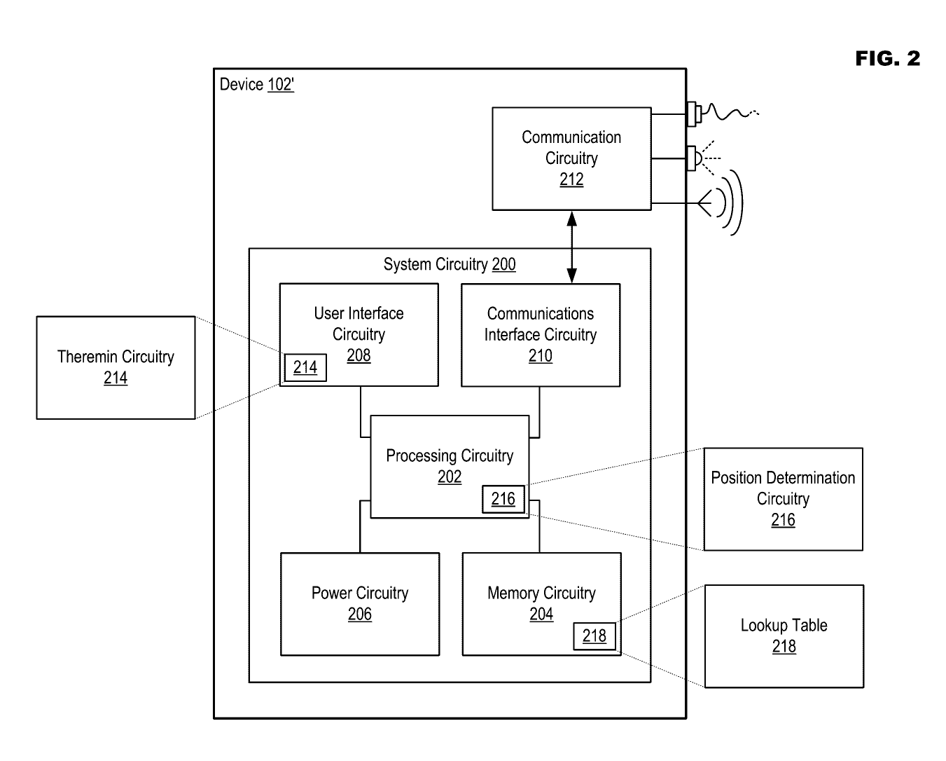

FIG. 2 illustrates an example configuration for a device usable in accordance with at least one embodiment of the present disclosure. Device 102′ may be capable of performing any or all of the activities illustrated in FIG. 1. While only one device 102′ is illustrated, consistent with the present disclosure multiple devices may cooperate to perform the activities associated with device 102′. Device 102′ is presented only as an example of an apparatus that may be employed in various embodiments consistent with the present disclosure, and is not intended to limit any of the various embodiments to any particular manner of configuration, implementation, etc.

Device 102′ may comprise at least system circuitry 200 to manage device operation. System circuitry 200 may include, for example, processing circuitry 202, memory circuitry 204, power circuitry 206, user interface circuitry 208 and communications interface circuitry 210. Device 102′ may further include communication circuitry 212. While communication circuitry 212 is shown as separate from system circuitry 200, the example configuration of device 102′ has been provided herein merely for the sake of explanation. Some or all of the functionality associated with communication circuitry 212 may also be incorporated into system circuitry 200.

In device 102′, processing circuitry 202 may comprise one or more processors situated in separate components, or alternatively one or more processing cores situated in one component (e.g., in a System-on-Chip (SoC) configuration), along with processor-related support circuitry (e.g., bridging interfaces, etc.). Example processors may include, but are not limited to, various x86-based microprocessors available from the Intel Corporation including those in the Pentium, Xeon, Itanium, Celeron, Atom, Quark, Core i-series, Core M-series product families, Advanced RISC (e.g., Reduced Instruction Set Computing) Machine or “ARM” processors or any other evolution of computing paradigm or physical implementation of such integrated circuits (ICs), etc. Examples of support circuitry may include chipsets (e.g., Northbridge, Southbridge, etc. available from the Intel Corporation) configured to provide an interface via which processing circuitry 202 may interact with other system components that may be operating at different speeds, on different buses, etc. in device 102′. Moreover, some or all of the functionality commonly associated with the support circuitry may also be included in the same physical package as the processor (e.g., such as in the Sandy Bridge family of processors available from the Intel Corporation).

Processing circuitry 202 may be configured to execute various instructions in device 102′. Instructions may include program code configured to cause processing circuitry 202 to perform activities related to reading data, writing data, processing data, formulating data, converting data, transforming data, etc. Information (e.g., instructions, data, etc.) may be stored in memory circuitry 204. Memory circuitry 204 may comprise random access memory (RAM) and/or read-only memory (ROM) in a fixed or removable format. RAM may include volatile memory configured to hold information during the operation of device 102′ such as, for example, static RAM (SRAM) or Dynamic RAM (DRAM). ROM may include non-volatile (NV) memory circuitry configured based on BIOS, UEFI, etc. to provide instructions when device 102′ is activated, programmable memories such as electronic programmable ROMs (EPROMS), Flash, etc. Other fixed/removable memory may include, but are not limited to, magnetic memories such as, for example, floppy disks, hard drives, etc., electronic memories such as solid state flash memory (e.g., embedded multimedia card (eMMC), etc.), removable memory cards or sticks (e.g., micro storage device (uSD), USB, etc.), optical memories such as compact disc-based ROM (CD-ROM), Digital Video Disks (DVD), Blu-Ray Disks, etc.

Power circuitry 206 may include internal power sources (e.g., a battery, fuel cell, etc.) and/or external power sources (e.g., electromechanical or solar generator, power grid, external fuel cell, etc.), and related circuitry configured to supply device 102′ with the power needed to operate. User interface circuitry 208 may include hardware and/or software to allow users to interact with device 102′ such as, for example, various input mechanisms (e.g., microphones, switches, buttons, knobs, keyboards, speakers, touch-sensitive surfaces, one or more sensors configured to capture images and/or sense proximity, distance, motion, gestures, orientation, biometric data, etc.) and various output mechanisms (e.g., speakers, displays, lighted/flashing indicators, electromechanical components for vibration, motion, etc.). The hardware in user interface circuitry 208 may be incorporated within device 102′ and/or may be coupled to device 102′ via a wired or wireless communication medium. In an example implementation wherein device 102′ is a multiple device system, user interface circuitry 208 may be optional in devices such as, for example, servers (e.g., rack/blade servers, etc.) that omit user interface circuitry 208 and instead rely on another device (e.g., an operator terminal) for user interface functionality.

Communications interface circuitry 210 may be configured to manage packet routing and other functionality for communication circuitry 212, which may include resources configured to support wired and/or wireless communications. In some instances, device 102′ may comprise more than one set of communication circuitry 212 (e.g., including separate physical interface circuitry for wired protocols and/or wireless radios) managed by communications interface circuitry 210. Wired communications may include serial and parallel wired or optical mediums such as, for example, Ethernet, USB, Firewire, Thunderbolt, Digital Video Interface (DVI), High-Definition Multimedia Interface (HDMI), etc. Wireless communications may include, for example, close-proximity wireless mediums (e.g., radio frequency (RF) such as based on the RF Identification (RFID) or Near Field Communications (NFC) standards, infrared (IR), etc.), short-range wireless mediums (e.g., Bluetooth, WLAN, Wi-Fi, ZigBee, etc.), long range wireless mediums (e.g., cellular wide-area radio communication technology, satellite-based communications, etc.), electronic communications via sound waves, lasers, etc. In one embodiment, communications interface circuitry 210 may be configured to prevent wireless communications that are active in communication circuitry 212 from interfering with each other. In performing this function, communications interface circuitry 210 may schedule activities for communication circuitry 212 based on, for example, the relative priority of messages awaiting transmission. While the embodiment disclosed in FIG. 2 illustrates communications interface circuitry 210 being separate from communication circuitry 212, it may also be possible for the functionality of communications interface circuitry 210 and communication circuitry 212 to be incorporated into the same circuitry.

Consistent with the present disclosure, Theremin circuitry 214, position determination circuitry 216 and/or lookup table 218 may comprise hardware, or combinations of hardware and software, to at least sense an object in proximity to electrodes 106A . . . D and generate positioning data for the object. “Hardware” as referenced herein, may include, for example, discrete analog and/or digital components (e.g., arranged on a printed circuit board (PCB) to form circuitry), at least one integrated circuit (IC), at least one group or set of ICs that may be configured to operate cooperatively (e.g., chipset), more than one interconnected IC fabricated on one substrate (SoC), or combinations thereof. For example, at least the hardware portion of Theremin circuitry 214 and position determining circuitry 216 may reside in user interface circuitry 208 and processing circuitry 202, respectively. In at least one example embodiment, part of position determination circuitry 216 and lookup table 218 may be comprise software (e.g., instructions, data, etc.) that, when loaded into RAM in memory circuitry 204, may cause at least processing circuitry 202 to transform from a general purpose data processor into specialized circuitry to perform specialized functions based at least on the software. In an example of operation, Theremin circuitry 214 may generate a frequency change based on hand 104 being in proximity to electrodes 106A . . . D. The change in frequency may be provided to position determination circuitry 216, which may employ lookup table 218 to determine distances 110A . . . D between electrodes 106A . . . D and hand 104. Lookup table may include, for example, a matrix of precomputed values for distances 110A . . . D based on the sensed frequency changes. Position determination circuitry 216 may then generate positioning data based on the distances. In at least one embodiment, the positioning data may then be provided to a requestor in device 102′ (e.g., to at least one application, in device 102′ that requested, or currently requires, the positioning data).

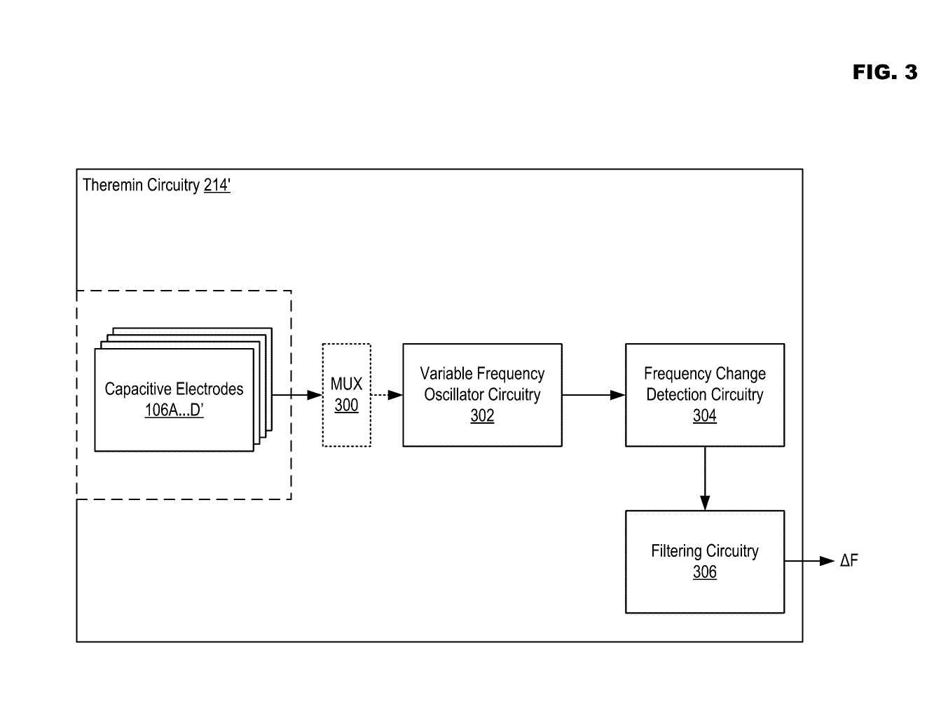

FIG. 3 illustrates example Theremin circuitry in accordance with at least one embodiment of the present disclosure. For the sake of reference, a typical Theremin instrument may comprise a pair of oscillators nominally tuned to the same frequency with a first reference oscillator that is highly stable and a second variable oscillator that is intentionally unstable and highly influenced by additive capacitance introduced by the presence of proximate objects (e.g., hand 104). The operating frequency is typically several MHz so as to maximize the capacitive frequency shift. The two oscillators may be heterodyned together and processed (e.g. filtered) to generate an audio tone. A more modern method, but still similar to the classical heterodyne approach, is the use of frequency conversion via sampling where the sampling frequency replaces the reference frequency. Here the sampling may be “real” or “complex” (i.e. I/Q) and the sampler may take the form of an analog-to-digital converter. The low pass filter may correspondingly be real or complex. Practical implementations may require a calibration method due to the pitch oscillator frequency instability so as establish the proper beat note operating frequency. That is, when no hand 104 is present the frequencies should be substantially equal so the frequency difference is practically zero. As the hand starts to come into close proximity of the pitch electrode, the added capacitance lowers the pitch oscillator frequency resulting in an increasing beat note difference frequency. The closer hand 104 is to the electrode, the larger the difference frequency. Typically the heterodyne approach uses a highly stable reference oscillator (i.e. crystal controlled) and thus the pitch oscillator may need an adjustable trimming capacitor to set the free running frequency.

The more modern method described above may allow the pitch oscillator to operate at its natural free running frequency and may then adjust the sampling frequency (e.g., using a digital synthesizer to generate the sampling clock). In the case of the complex sampler, the frequency offset due to the pitch oscillator drift may be digitally corrected using a digital synthesizer and a complex multiplier. An alternate implementation removes the reference oscillator and processes the pitch oscillator directly in the digital domain to establish a virtual reference frequency. The frequency of the pitch oscillator may be constantly monitored by a digital frequency counter. Digital averaging may be utilized at the output of the frequency counter to estimate the mean operating frequency of the pitch oscillator. Given the assumption that there are periods when no human is in the proximity of the electrode, the mean operating frequency of the pitch oscillator may be determined. However, the mean frequency of the pitch oscillator may still be influenced by the surrounding environment (e.g., the presence of metallic objects, etc.). This final method may be self-calibrating in the digital domain in that, when an object is proximate to an electrode, the instantaneous frequency of the pitch oscillator is reduced and is detected by the frequency difference circuit.

In view of the above, Theremin circuity 214′ may comprise, for example, electrodes 106A . . . D′, variable frequency oscillator circuitry 302, frequency change detection circuitry 304 and filtering circuitry 306. As indicated by the dotted outline, electrodes 106A . . . D′ may reside in Theremin circuitry 214′ (e.g., when Theremin circuitry 214′ is integrated into device 102), or alternatively, may be externally located and coupled to Theremin circuitry 214′ via wired and/or wireless communication (e.g., when Theremin circuitry 214′ is part of a positioning system that is later added-on to device 102). In an example of operation, an object in proximity to capacitive electrodes 106A . . . D′ may trigger frequency changes in signals generated by at least one variable frequency oscillator circuitry 304 (e.g., including a variable oscillator). Frequency changes may be detected by frequency change detection circuitry 304 (e.g., including a reference oscillator or digital detection circuitry as described above), the output of which may be filtered by filtering circuitry (e.g., including at least a low pass filter) to generate ΔF. In at least one embodiment, Theremin circuitry 214′ may comprise a separate set of variable frequency oscillator circuitry 302, frequency change detection circuitry 304 and filtering circuitry 306 corresponding to each electrode 106A . . . D′. Alternatively, Theremin circuitry 214′ may be configured to comprise at least a multiplexer (MUX) 300 to switch electrodes 106A . . . D′ between a single set of variable frequency oscillator circuitry 302, frequency change detection circuitry 304 and filtering circuitry 306, which may help conserve resources (e.g., space, power, etc.) in device 102.

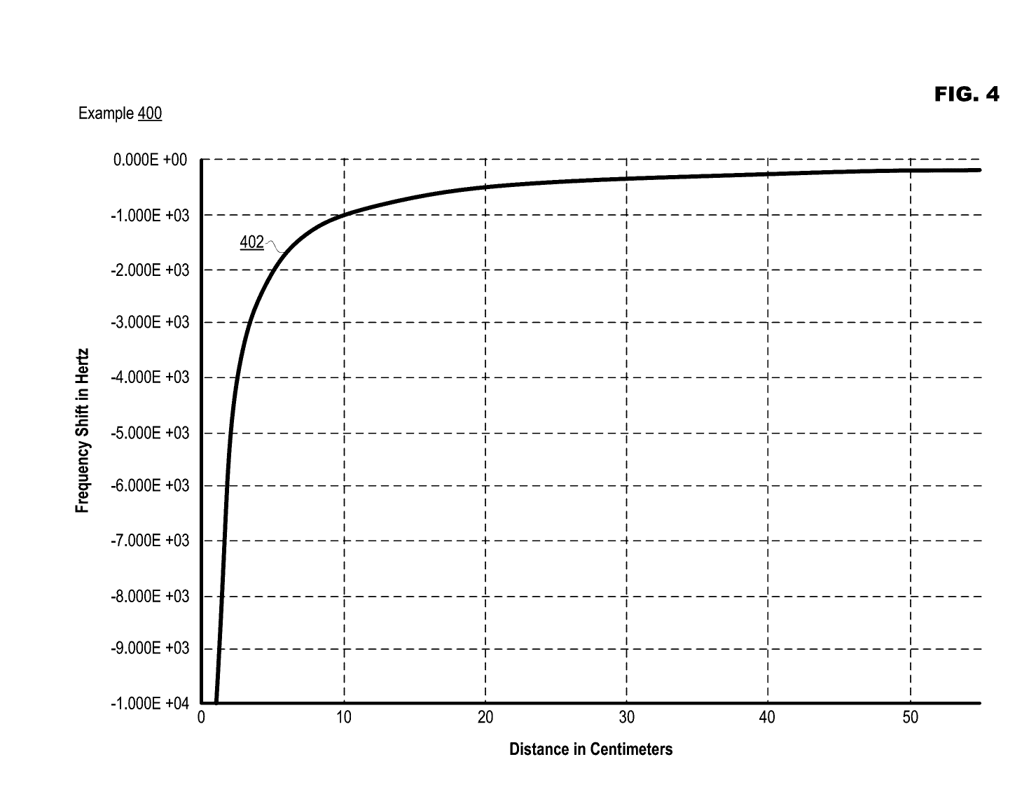

FIG. 4 illustrates an example graph of a frequency to location relationship in accordance with at least one embodiment of the present disclosure. In general, there may be a deterministic relationship between the proximity of hand 104 to electrodes 106A . . . D. This relationship may be complex (e.g., best empirically derived), and thus, it may depend upon a number of variables such as a nominal operating frequency of the pitch oscillator and configuration of the capacitive electrode. To generally illustrate the concept of proximity positioning, it may be assumed that a relationship between the pitch frequency difference and the position of hand 104 is represented by the following equation, wherein each distance 110A . . . D (D_{cm}) is given in centimeters (cm) and k is a sensitivity constant.

$${F}_{diff} = \frac{k}{{D}_{cm}} \qquad ( 1 )$$

An example of this relationship is disclosed in example graph 400. The constant k and the actual shape of curve 402 may be dependent on, for example, the particular configuration of at least electrodes 106A . . . D and variable frequency oscillator circuitry 302. In instances where each electrode 106A . . . D has corresponding variable frequency oscillator circuitry 302, k may be determined for each electrode/oscillator pair. In a converse manner for the given assumptions, if we measure the variable oscillator frequency difference ΔF then distances 110A . . . D (D_{cm}) may be calculated as follows:

$${D}_{cm} = \frac{k}{{F}_{diff}} \qquad ( 2 )$$

For the sake of explanation herein, device 102 may be, for example, a monitor including four electrodes 106A . . . D along with associated Theremin circuitry 214 embedded in the bezel. Utilizing any of the Theremin oscillator configurations described herein, a frequency difference may be measured and employed to calculate a corresponding distance 110A . . . D. As previously discussed, each distance may define a sphere having a radius equal to the calculated distance 110A . . . D. The center may be located at the corresponding electrode 106A . . . D. The location of the hand 104 is at the intersection of the related spheres. A closed form solution involves solving a set of simultaneous equations:

$$\begin{matrix}A = [ \begin{matrix}{x}_{1}^{0} - {x}_{2}^{0} & {y}_{1}^{0} - {y}_{2}^{0} & {z}_{1}^{0} - {z}_{2}^{0} \\ {x}_{2}^{0} - {x}_{3}^{0} & {y}_{2}^{0} - {y}_{3}^{0} & {z}_{2}^{0} - {z}_{3}^{0} \\ {x}_{3}^{0} - {x}_{4}^{0} & {y}_{3}^{0} - {y}_{4}^{0} & {z}_{3}^{0} - {z}_{4}^{0}\end{matrix} ] B = [ \begin{matrix}{k}_{21} \\ {k}_{32} \\ {k}_{43}\end{matrix} ] C = [ \begin{matrix}{D}_{2}^{2} - {D}_{1}^{2} \\ {D}_{3}^{2} - {D}_{2}^{2} \\ {D}_{4}^{2} - {D}_{3}^{2}\end{matrix} ] & ( 3 ) \\ {k}_{21} = \{ ( {[ {x}_{2}^{0} ]}^{2} - {[ {x}_{1}^{0} ]}^{2} ) + ( {[ {y}_{2}^{0} ]}^{2} - {[ {y}_{1}^{0} ]}^{2} ) + ( {[ {z}_{2}^{0} ]}^{2} - {[ {z}_{1}^{0} ]}^{2} ) \} & ( 4 ) \\ {k}_{32} = \{ ( {[ {x}_{3}^{0} ]}^{2} - {[ {x}_{2}^{0} ]}^{2} ) + ( {[ {y}_{3}^{0} ]}^{2} - {[ {y}_{2}^{0} ]}^{2} ) + ( {[ {z}_{3}^{0} ]}^{2} - {[ {z}_{2}^{0} ]}^{2} ) \} & ( 5 ) \\ {k}_{43} = \{ ( {[ {x}_{4}^{0} ]}^{2} - {[ {x}_{3}^{0} ]}^{2} ) + ( {[ {y}_{4}^{0} ]}^{2} - {[ {y}_{3}^{0} ]}^{2} ) + ( {[ {z}_{4}^{0} ]}^{2} - {[ {z}_{3}^{0} ]}^{2} ) \} & ( 6 ) \\ PT = [ \begin{matrix}x \\ y \\ z\end{matrix} ] = \frac{1}{2} {A}^{- 1} ( C - B ) & ( 7 )\end{matrix}$$

While simultaneous equations have been shown, numerical methods may also be used such as indexing an appropriately generated lookup table 218. For example, given a 40 cm by 30 cm display (e.g., device 102) a coordinate system may be defined having an origin directly below screen center at the base of a 10 cm high stand. An object (e.g., hand 104) may be located at (−20, −30, 10). For this example it may be assumed that at least variable frequency oscillator circuitry 302 is operating in the 6.765 MHz to 6.795 MHz Industrial, Scientific and Medical (ISM) band, at a nominal frequency of 6.78 MHz (e.g., with no hand 104 present) and have been characterized in regards to the frequency delta vs. hand distance graph as shown at 400 in FIG. 4. Based on the position of hand 104 being (−20, −30, 10), the following frequency differences may be observed by (e.g., sensed with) Theremin circuitry 214:

F_{diff}¹=−182 Hz F_{diff}²=−238 Hz F_{diff}³=−313 Hz F_{diff}⁴=−238 Hz

The above observed frequency differences may be translated into distances 110A . . . D from each of electrodes 106A . . . D based on the relationship shown in equation (2) as follows:

$${D}_{cm}^{1} = 54 cm \qquad {D}_{cm}^{2} = 42 cm \qquad {D}_{cm}^{3} = 32 cm \qquad {D}_{cm}^{4} = 42 cm$$

$$A = [ \begin{matrix}10 & 1 & 20 \\ 30 & - 1 & - 10 \\ 0 & 0 & - 20\end{matrix} ] B = [ \begin{matrix}- 1099 \\ 599 \\ 1200\end{matrix} ] C = [ \begin{matrix}- 1.1590 e 3 \\ - 0.7410 e 3 \\ 0.8000 e 3\end{matrix} ]$$

Solving for the position vector may generate a ground truth location of hand 104 in the coordinate system defined based on the monitor (e.g., device 102), which matches the original location set forth for this example (e.g., rounded from floating point precision for simplicity):

$$PT = [ \begin{matrix}- 20.0 \\ - 30.0 \\ - 10.0\end{matrix} ]$$

To solve for the location of hand 104, the “A” matrix in equation (3) must be invertible, which may be determined by the configuration of the electrodes. That is, the location of the electrodes is critical in order to guarantee a solution. Consistent with the present disclosure, there must be at least four electrodes 106A . . . D, of which at least one of electrodes 106A . . . D must not be in the same plane as the other three. A “condition number” of the A matrix can be used as a guide to determine where to place electrodes 106A . . . D (e.g., in the depicted example on a display). The condition number is a function (e.g., the “A” matrix in equation (3)) with respect to an argument (e.g., the positions of each of electrodes 106A . . . D) that may measure how much an output value of the function (e.g., the positioning data) may change for a small change in the input argument. The condition number may be used to measure how sensitive a function is to changes or errors in the input, and how much error in the output results from an error in the input. A number close to unity may indicate satisfactory placement of electrodes 106A . . . D. For example, placing electrodes 106A . . . D in nearly the same plane (e.g., so that all sensing surfaces 114 corresponding to electrodes 106A . . . D protrude 1.0 millimeters (mm) above surface 112 of device 102) results in a poorly conditioned A matrix (e.g., and the generation of imprecise positioning data). However, placing at least one sensing surface 114 (e.g., of electrode 106C′) to protrude above surface 112 by 1.0 cm results in a satisfactory condition number. The condition number determination may be performed when device 102 is being designed (e.g., for systems 100 wherein Theremin circuitry 214 is integrated within device 102). However, for an embodiment where Theremin circuitry 214 is an add-on to system 100 control device 102, the condition number determination may be performed after system initialization to ensure that the arrangement of electrodes 106A . . . D will generate accurate positioning data. For example, a user may place electrodes 106A . . . D in an arrangement to sense objects (e.g., hand 104). Electrodes 106A . . . D do not have to be physically coupled to device 102 such as, for example, in an instance where device 102 is located in an area not directly accessible to people such as a hazardous area (e.g., a caustic or explosive environment), etc. Device 102 may then execute an algorithm to test the positions (e.g., by computing a condition number mathematically using user inputted data or sensed data, empirically via a test interaction between a user and Theremin circuitry 214, etc.) to determine if electrodes 106A . . . D need repositioning to generate more accurate positioning data.

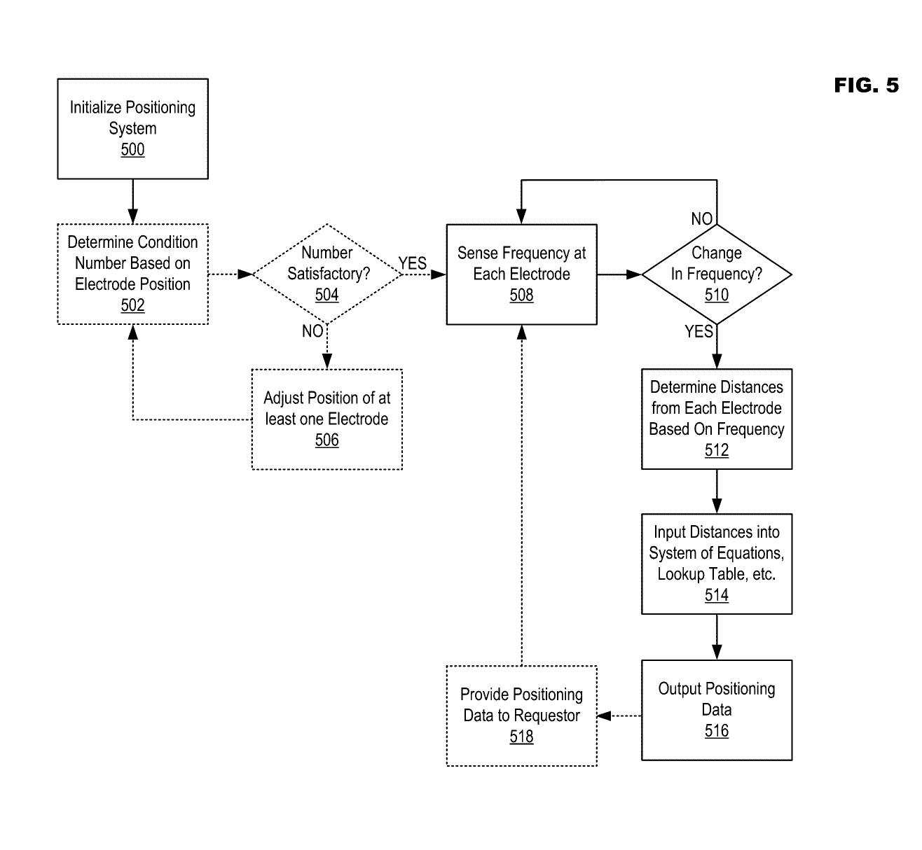

FIG. 5 illustrates example operations for Theremin-based positioning in accordance with at least one embodiment of the present disclosure. Operations illustrated with dotted lines may be optional in that only certain implementations may incorporate these operations based on, for example, the application for which the implementation is intended, the type of implementation (e.g., with integrated or added-on Theremin circuitry), the abilities of the equipment used in the implementation, etc. The positioning system may be initiated in operation 500. In operation 502 a condition number may be determined based on, for example, the arrangement of electrodes in the Theremin circuitry. A determination may then be made in operation 504 as to whether the condition number is satisfactory (e.g., approaches unity). If in operation it is determined that the condition number is unsatisfactory, then the position of at least one electrode may be adjusted in operation 506, which may be followed by operation 502 to re-determine the condition number.

A determination in operation 504 that the condition number determined in operation 502 is satisfactory may be followed by operation 508 wherein a frequency of a signal generated for each electrode is sensed. A determination may then be made in operation 510 as to whether the frequency at any electrode has changed due to, for example, an object being proximate to any of the electrodes. Sensing may continue until a change is determined in operation 510, after which in operation 512 the distances from each electrode to the object may be determined. In operation 514 the distances may then be input into a system of equations, a lookup table, etc. to determine positioning data, which may be output in operation 516. The positioning data may comprise, for example, coordinates of the object within a coordinate system relative to the electrodes, relative to a device being controlled by a Theremin-based positioning system, coordinates of the object within an absolute coordinate system etc., orientation data corresponding to the object, motion data corresponding to the object (e.g., data regarding direction, acceleration or speed), etc. The positioning data may then be provided to a requestor in operation 518. A requestor may be, for example, an application in the device that requested, or requires, the positioning data. Operation 518 may optionally be followed by operation 508 to continue sensing for frequency changes.

While FIG. 5 illustrates operations according to an embodiment, it is to be understood that not all of the operations depicted in FIG. 5 are necessary for other embodiments. Indeed, it is fully contemplated herein that in other embodiments of the present disclosure, the operations depicted in FIG. 5, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

As used in any embodiment herein, the terms “system” or “module” may refer to, for example, software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry or future computing paradigms including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums (e.g., non-transitory storage mediums) having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software executed by a programmable control device.

Thus, this disclosure pertains to Theremin-based positioning. In general, Theremin technology may operate based on changes in frequency that may be induced in a signal when a certain object (e.g., a user's hand) is proximate to a capacitive electrode. An example system may comprise at least four capacitive electrodes in an arrangement that reacts to proximate objects. A change in frequency sensed for any of the at least four capacitive electrodes may trigger a determination of distance from each of the capacitive electrodes to the object based on the frequency change, and a determination of object positioning data based on the distances. Embodiments may include, for example, the ability to verify the arrangement of the at least four capacitive electrodes, determine object position and/or orientation in a coordinate system referenced to the at least four capacitive electrodes, determine object motion, provide the positioning data to a requesting application, etc.

The following examples pertain to further embodiments. The following examples of the present disclosure may comprise subject material such as at least one device, a method, at least one machine-readable medium for storing instructions that when executed cause a machine to perform acts based on the method, means for performing acts based on the method and/or a system for Theremin-based positioning.

According to example 1 there is provided a system to determine positioning data related to proximate objects. The system may comprise Theremin circuitry to generate a variable frequency signals and sense variations in the frequencies of the signals induced by an object proximate to the Theremin circuitry and processing circuitry to at least determine distances to the object based on the induced frequency changes and determine positioning data for the object based on the distances.

Example 2 may include the elements of example 1, wherein the Theremin circuitry comprises at least four capacitive electrodes to induce variation in the signals when the object is proximate to the capacitive electrodes.

Example 3 may include the elements of example 2, wherein the at least four capacitive electrodes are arranged on a device to be controlled by movement proximate to the device.

Example 4 may include the elements of example 3, wherein the device is a multimedia data presentation device and the movement proximate to the device is to control operations related to presenting multimedia data on the device.

Example 5 may include the elements of any of examples 3 to 4, wherein the at least four capacitive electrodes are embedded within the device.

Example 6 may include the elements of any of examples 3 to 5, wherein the at least four capacitive electrodes are coupled to the processing circuitry via wired communication.

Example 7 may include the elements of any of examples 3 to 6, wherein the at least four capacitive electrodes are coupled to the processing circuitry via wireless communication.

Example 8 may include the elements of any of examples 2 to 7, wherein at least one of the at least four capacitive electrodes is arranged so as not to be in the same plane as the remaining capacitive electrodes.

Example 9 may include the elements of example 8, wherein the arrangement of the at least four capacitive electrodes is tested to determine if a condition number relationship for the arrangement approaches unity.

Example 10 may include the elements of example 9, wherein the processing circuitry is to test the arrangement of the at least four capacitive electrodes and output a condition number based on the condition number relationship.

Example 11 may include the elements of any of examples 2 to 10, wherein the Theremin circuitry further comprises variable frequency oscillator circuitry, frequency change detector circuitry and filtering circuitry coupled to the at least four capacitive electrodes.

Example 12 may include the elements of example 11, wherein the Theremin circuitry further comprises a multiplexer to couple the at least four capacitive sensors to the variable frequency oscillator circuitry.

Example 13 may include the elements of any of examples 11 to 12, wherein the processing circuitry comprises position determination circuitry to at least determine the distances based on the induced frequency changes and a constant characterized for each of the at least four capacitive electrodes and the variable frequency oscillator circuitry.

Example 14 may include the elements of example 13, wherein the position determination circuitry is to at least determine coordinates corresponding to a location of the object in a coordinate system defined based on an arrangement of the at least four capacitive electrodes by inputting the distances into a set of closed form simultaneous equations.

Example 15 may include the elements of any of examples 13 to 14, further comprising memory circuitry and the position determination circuitry is to at least determine coordinates corresponding to a location of the object in a coordinate system defined based on an arrangement of the at least four capacitive electrodes by inputting the distances into a lookup table in the memory circuitry.

Example 16 may include the elements of any of examples 1 to 15, wherein positioning data comprises at least one of an object position, object orientation, object motion, object acceleration or object speed.

According to example 17 there is provided a method for Theremin-based positioning. The method may comprise initializing a Theremin-based positioning system, sensing frequencies in variable frequency signals generated by Theremin circuitry, determining if at least one frequency in the sensed frequencies has changed based on an object in proximity to the Theremin circuitry, determining at least one distance to the object from the Theremin circuitry based at least on any determined frequency changes and determining positioning data for the object based at least on the at least one distance.

Example 18 may include the elements of example 17, wherein the Theremin circuitry comprises at least four capacitive electrodes to induce variation in the signals when the object is proximate to the capacitive electrodes.

Example 19 may include the elements of example 18, wherein determining if at least one frequency in the sensed frequencies has changed comprises at least determining whether frequencies corresponding to each of the at least four capacitive electrodes have changed.

Example 20 may include the elements of example 19, wherein determining whether frequencies corresponding to each of the at least four capacitive electrodes have changed comprises serially coupling each of the at least four capacitive electrodes to a single set of circuitry to perform the determination.

Example 21 may include the elements of any of examples 18 to 20, wherein determining at least one distance comprises at least determining a distance from each of the at least four capacitive electrodes to the object.

Example 22 may include the elements of any of examples 18 to 21, wherein determining a position for the object comprises at least determining coordinates corresponding to a location of the object in a coordinate system defined based on an arrangement of the at least four capacitive electrodes by inputting the distances into at least one of a set of closed form simultaneous equations or a lookup table.

Example 23 may include the elements of any of examples 18 to 22, and may further comprise determining a condition number based on inputting a placement for each of the at least four capacitive electrodes into a condition number relationship, determining whether the condition number is satisfactory and adjusting the placement of at least one capacitive electrode based on the determination as to whether the condition number is satisfactory.

Example 24 may include the elements of any of examples 17 to 23, and may further comprise providing the positioning data to a requestor.

According to example 25 there is provided a system including at least one device, the system being arranged to perform the method of any of the above examples 17 to 24.

According to example 26 there is provided a chipset arranged to perform the method of any of the above examples 17 to 24.

According to example 27 there is provided at least one machine readable medium comprising a plurality of instructions that, in response to be being executed on a computing device, cause the computing device to carry out the method according to any of the above examples 17 to 24.

According to example 28 there is provided at least one device to perform Theremin-based positioning, the at least one device being arranged to perform the method of any of the above examples 17 to 24.

According to example 29 there is provided a system for Theremin-based positioning. The system may comprise means for initializing a Theremin-based positioning system, means for sensing frequencies in variable frequency signals generated by Theremin circuitry, means for determining if at least one frequency in the sensed frequencies has changed based on an object in proximity to the Theremin circuitry, means for determining at least one distance to the object from the Theremin circuitry based at least on any determined frequency changes and means for determining positioning data for the object based at least on the at least one distance.

Example 30 may include the elements of example 29, wherein the Theremin circuitry comprises at least four capacitive electrodes to induce variation in the signals when the object is proximate to the capacitive electrodes.

Example 31 may include the elements of example 30, wherein the means for determining if at least one frequency in the sensed frequencies has changed comprise means for at least determining whether frequencies corresponding to each of the at least four capacitive electrodes have changed.

Example 32 may include the elements of example 31, wherein the means for determining whether frequencies corresponding to each of the at least four capacitive electrodes have changed comprise means for serially coupling each of the at least four capacitive electrodes to a single set of circuitry to perform the determination.

Example 33 may include the elements of any of examples 30 to 32, wherein the means for determining at least one distance comprise means for at least determining a distance from each of the at least four capacitive electrodes to the object.

Example 34 may include the elements of any of examples 30 to 33, wherein the means for determining a position for the object comprise means for at least determining coordinates corresponding to a location of the object in a coordinate system defined based on an arrangement of the at least four capacitive electrodes by inputting the distances into at least one of a set of closed form simultaneous equations or a lookup table.

Example 35 may include the elements of any of examples 30 to 34, and may further comprise means for determining a condition number based on inputting a placement for each of the at least four capacitive electrodes into a condition number relationship and means for determining whether the condition number is satisfactory.

Example 36 may include the elements of any of examples 30 to 35, and may further comprise means for providing the positioning data to a requestor.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

What is claimed:

1. A system to determine positioning data related to proximate objects, comprising:
Theremin circuitry to generate a variable frequency signals and sense variations in the frequencies of the signals induced by an object proximate to the Theremin circuitry; and
processing circuitry to at least determine distances to the object based on the induced frequency changes and determine positioning data for the object based on the distances.

2. The system of claim 1, wherein the Theremin circuitry comprises at least four capacitive electrodes to induce variation in the signals when the object is proximate to the capacitive electrodes.

3. The system of claim 2, wherein the at least four capacitive electrodes are arranged on a device to be controlled by movement proximate to the device.

4. The system of claim 2, wherein at least one of the at least four capacitive electrodes is arranged so as not to be in the same plane as the remaining capacitive electrodes.

5. The system of claim 4, wherein the arrangement of the at least four capacitive electrodes is tested to determine if a condition number relationship for the arrangement approaches unity.

6. The system of claim 2, wherein the Theremin circuitry further comprises variable frequency oscillator circuitry, frequency change detector circuitry and filtering circuitry coupled to the at least four capacitive electrodes.

7. The system of claim 6, wherein the Theremin circuitry further comprises a multiplexer to couple the at least four capacitive sensors to the variable frequency oscillator circuitry.

8. The system of claim 6, wherein the processing circuitry comprises position determination circuitry to at least determine the distances based on the induced frequency changes and a constant characterized for each of the at least four capacitive electrodes and the variable frequency oscillator circuitry.

9. The system of claim 8, wherein the position determination circuitry is to at least determine coordinates corresponding to a location of the object in a coordinate system defined based on an arrangement of the at least four capacitive electrodes by inputting the distances into a set of closed form simultaneous equations.

10. The system of claim 8, further comprising memory circuitry and the position determination circuitry is to at least determine coordinates corresponding to a location of the object in a coordinate system defined based on an arrangement of the at least four capacitive electrodes by inputting the distances into a lookup table in the memory circuitry.

11. The system of claim 1, wherein positioning data comprises at least one of an object position, object orientation, object motion, object acceleration or object speed.

12. A method for Theremin-based positioning, comprising:
initializing a Theremin-based positioning system;
sensing frequencies in variable frequency signals generated by Theremin circuitry;
determining if at least one frequency in the sensed frequencies has changed based on an object in proximity to the Theremin circuitry;
determining at least one distance to the object from the Theremin circuitry based at least on any determined frequency changes; and
determining positioning data for the object based at least on the at least one distance.

13. The method of claim 12, wherein the Theremin circuitry comprises at least four capacitive electrodes to induce variation in the signals when the object is proximate to the capacitive electrodes.

14. The method of claim 13, wherein determining if at least one frequency in the sensed frequencies has changed comprises at least determining whether frequencies corresponding to each of the at least four capacitive electrodes have changed.

15. The method of claim 14, wherein determining whether frequencies corresponding to each of the at least four capacitive electrodes have changed comprises serially coupling each of the at least four capacitive electrodes to a single set of circuitry to perform the determination.

16. The method of claim 13, wherein determining at least one distance comprises at least determining a distance from each of the at least four capacitive electrodes to the object.

17. The method of claim 13, wherein determining a position for the object comprises at least determining coordinates corresponding to a location of the object in a coordinate system defined based on an arrangement of the at least four capacitive electrodes by inputting the distances into at least one of a set of closed form simultaneous equations or a lookup table.

18. The method of claim 13, further comprising:
determining a condition number based on inputting a placement for each of the at least four capacitive electrodes into a condition number relationship;
determining whether the condition number is satisfactory; and
adjusting the placement of at least one capacitive electrode based on the determination as to whether the condition number is satisfactory.

19. At least one machine-readable storage medium having stored thereon, individually or in combination, instructions for Theremin-based positioning that, when executed by one or more processors, cause the one or more processors to:
initialize a Theremin-based positioning system;
sense frequencies in variable frequency signals generated by Theremin circuitry;
determine if at least one frequency in the sensed frequencies has changed based on an object in proximity to the Theremin circuitry;
determine at least one distance to the object from the Theremin circuitry based at least on any determined frequency changes; and
determine positioning data for the object based at least on the at least one distance.

20. The storage medium of claim 19, wherein the Theremin circuitry comprises at least four capacitive electrodes to induce variation in the signals when the object is proximate to the capacitive electrodes.

21. The storage medium of claim 20, wherein the instructions to determine if at least one frequency in the sensed frequencies has changed comprise instructions to at least determine whether frequencies corresponding to each of the at least four capacitive electrodes have changed.

22. The storage medium of claim 21, wherein the instructions to determine whether frequencies corresponding to each of the at least four capacitive electrodes have changed comprise instructions to serially couple each of the at least four capacitive electrodes to a single set of circuitry to perform the determination.

23. The storage medium of claim 20, wherein the instructions to determine at least one distance comprise instructions to at least determine a distance from each of the at least four capacitive electrodes to the object.

24. The storage medium of claim 20, wherein the instructions to determine a position for the object comprise instructions to at least determine coordinates corresponding to a location of the object in a coordinate system defined based on an arrangement of the at least four capacitive electrodes by inputting the distances into at least one of a set of closed form simultaneous equations or a lookup table.

25. The storage medium of claim 20, further comprising instructions that, when executed by one or more processors, cause the one or more processors to:
determine a condition number based on inputting a placement for each of the at least four capacitive electrodes into a condition number relationship; and
determine whether the condition number is satisfactory.
